(19) United States
(12) Patent Application Publication
(10) Pub. No.: US 2016/0143711 A1
(43) Pub. Date: May 26, 2016

(54) DENTAL IMPLANT INSERT ADAPTOR

(71) Applicant: Iulian HONIG, Bucharest (RO)

(72) Inventor: Iulian HONIG, Bucharest (RO)

(21) Appl. No.: 14/905,792

(22) PCT Filed: Jul. 16, 2014
(86) PCT No.: PCT/IL2014/050643

§ 371 Date: Jan. 16, 2016

Related U.S. Application Data
(60) Provisional application No. 61/846,642, filed on Jul. 16, 2013.

(51) Int. Cl. A61C 8/00

(52) U.S. Cl. CPC A61C 8/0072; A61C 8/0054; A61C 8/006; A61C 8/0022; A61C 8/0001; A61C 8/0068; A61C 8/008; A61C 8/0074

(57) ABSTRACT

The present invention relates to multi-piece dental implants comprising an anchor and abutment assembly and in particular, to such a dental implant system and an insert adaptor that facilitates coupling between an implant anchor and an abutment member may be coupled over a single position one-way coupling interface in a one to one manner, where the one-way coupling interface may be integrated with an anchor or coupled to an off the shelf anchor in the form of an insert.

### FIELD OF THE INVENTION

The present invention relates to multi-piece dental implants comprising an anchor and abutment assembly and in particular, to such a dental implant system and an insert adaptor that provides a single position one-way coupling platform.

### BACKGROUND OF THE INVENTION

Dental implants are known in the art and typically include a dental anchor, an abutment and a prosthodontic restoration. The dental anchor is securely inserted into the patient's jawbone, the abutment member is attached to the anchor and utilized to interface and couple with the prosthodontic restoration to the anchor.

Prior art and/or off the shelf implant anchors, for example as show FIG. 1A-C, are screw form implants (32) that are inserted into the jawbone, mandible and/or maxilla, and used to replace a dental tooth. The implant anchor (32) comprise an anti-rotation coupling interface 38 to facilitate tooling of the anchor so as to allow for inserting the implant anchor into the jawbone. The anti-rotation coupling interface 38 is also serves for coupling an abutment thereto in a number of configuration and/or positions while preventing the rotation of the abutment within the anchor implant 32. Therefore the coupling interface 38, shown in the form of an internal hex interface provides for coupling an abutment in up to six positions and therefore exemplifies one form of a multi-position coupling interface. Such multi-position anti-rotational interfaces 38 are commonplace and greatly vary between manufacturers. Such coupling interfaces that are known in the art include: internal six receptor sockets, scalloped, internal dodecagon, external hex, internal hex, internal octagon, external octagon, external spline, external morse taper, internal morse taper, internal six lobe, internal tri lobe, internal six spline, internal thread, internal pentagon, external thread, internal square, external square, internal five lobe, internal four lobe, internal three spline, external triangle, internal eight spline, external six lobe, internal eight lobe, internal tube to tube and plug in.

The coupling interface allows the abutment to be placed in a plurality of positions. For example, as its name suggests an “internal hex”, as shown in FIG. 1A-B, refers to a hexagonal interface that allows the abutment to be placed in six different positions relative to the anchor's axis. Such an “internal hex” interface is described in U.S. Pat. No. 4,960,381 to Niznick.

The various anchor coupling interfaces 38, (for example as shown in FIG. 1A-B), provide physicians some degrees of freedom to allow them to position the abutment in various position and orientation relative to the morphological and clinical situation. However, recent technological and digital medical imagery developments have found their way to dental implant technology. Medical imagery technique such as CT scans and improved computer technology and image processing has contributed to the development of individualized and/or customized dental abutments.

Individualized and/or customized abutments are designed and produced with computer assistance design (CAD) and computer assisted manufacturing (CAM) tools and technology generally referred to as CAD/CAM. CAD/CAM tools are utilized to design and manufacture customized and/or individualized abutments for a specific patient based on the medical imagery of the patient so as to best suit the patient from a clinical and anatomical perspective. Such individualized abutments are designed to couple with standard prefabricated anchors such as those depicted in FIG. 1A-C.

### SUMMARY OF THE INVENTION

A problem arises when coupling a customized dental implant abutment to a state of the art prefabricated anchor because there is no manner by which a practitioner can ensure the correct coupling orientation of the abutment to the anchor so as to allow the customized abutment to assume its intended orientation, to best suit the patient from a clinical and anatomical perspective. This problem is primarily due to the fact that the off the shelf implant 32 utilized having a coupling platform 38 is a multi-position coupling interface such that the practitioner has a one in six chance is choosing the correct abutment orientation and no guarantee that the right orientation will be selected.

As discussed above state of the art (off the shelf) implant anchors 32 are provided with a coupling interface 38 that allows an abutment to be placed and coupled in a plurality of positions.

Accordingly, prior art anchor's coupling interfaces, for example the internal hex interface 38 of FIG. 1A-C, provides many abutment to anchor coupling positions and cannot ensure that a customized and/or individualized abutment is oriented and mounted onto the anchor in its pre-planned and/or intended position.

Specifically prior art anchor's coupling interfaces, for example the internal hex 38 shown in FIG. 1A, provide a practitioner with multiple positions, specifically six, with which a customized and/or individualized restoration and/or abutments may be placed. With such multi-position coupling interfaces, a practitioner does not have a way to ensure the correct placement and positioning of a customized abutment and/or restoration on the standard off the shelf implant according to having prior art multi-position coupling interfaces.

The present invention overcomes these deficiencies of the background by providing a dental implant anchor having a single position one-way coupling platform and/or interface so as to ensure correct orientation and positioning of a customized and/or individualized abutment within the jaw.

The present invention overcomes the deficiencies of prior art implant anchors by providing an insert adaptor configured to convert a multi-position connection platform into a single position one-way coupling platform therein allowing off the shelf implant anchors to be used with individualized and/or customized implant abutments.

In embodiments of the present invention define a single position one-way coupling platform that may utilized on any prosthodontic elements for example including implants, abutments, insert adaptors, restorations, impression coping, or the like. Optionally the single position coupling platform comprises at least one coupling member provided to ensure a one-way coupling. Optionally and preferably the single position coupling platform comprises at least two coupling members that are different from one another about at least one parameters for example including but not limited to size, dimension, shape, geometry the like or any combination thereof. Optionally and preferably the at least two coupling members may be disposed adjacent to one another and more preferably opposite one another. An optional embodiment of the present invention provides a dental implant anchor insert adaptor provided to convert a multi position coupling platform disposed on an off the shelf dental implant anchor to a single position one-way coupling platform the insert adaptor is configured to fit within at least a proximal portion of an off the shelf implant borehole where the multi-position coupling platform is defined, the insert adaptor features a substantially tubular body defining a distal end, a proximal end, an external surface and an internal surface; the external surface are configured to correspond to and securely fit with a multi position coupling platform of an off the shelf implant anchor; the inner surface is configured to define a single position one-way coupling platform.

An optional embodiment of the present invention the insert adaptor wherein a single position one-way coupling platform (738) is configured to correspond to and couple with a single position one-way coupling platform disposed on a prosthodontic elements selected from the group consisting of: impression coping, implant abutment, a personalized implant abutment, fixation screw, a CAD/CAM personalized implant abutment, a manually customizable abutment assembly, healing abutment, healing cap, cover screw, or the like.

An optional embodiment of the present invention provides a dental implant anchor having a screw form configuration for placement within the maxilla or mandible having an external surface comprising threading facilitating placement within the maxilla or mandible, and a central borehole for interfacing and/or coupling the implant anchor with additional prosthodontic elements, the borehole having a proximal portion and a distal portion that are continuous with one another, wherein the surface of the borehole proximal portion is a continuous curved surface defining a single position one-way coupling platform provided for one-way coupling with optional prosthodontic elements, the one way connection platform characterized in that: the curved surface is a continuous surface defining an irregular circle having up to one line of symmetry; wherein up to about 50% of the curved surface is has a constant radius and provides an implant margin of at least 0.3 mm.

Optionally and preferably the curved surface is configured to further comprise at least one coupling member extending from a portion of the curved surface.

Within the context of this application the terms individually customizable, adjustable and/or customizable dental implant systems, interchangeably refer to an adjustable and customizable implant system particularly an abutment assembly, as described in a co-owned and pending PCT Application No. PCT/IB2012/053829, the contents of which are incorporated herein by reference as if fully set forth herein.

Within the context of this application the terms CAD/CAM personalized, CAD/CAM individualized, CAD/CAM manufactured and/or CAD/CAM customized, dental abutment or restoration, interchangeably refer to a dental implant abutment and/or restoration that is designed and manufactured for a specific individual (patient) based on medical imaging, computer tomographic images (CT), and a CAD/CAM technologies as is known in the art.

Within the context of this application the terms one-way coupling platform and/or one-position coupling platform and/or single position coupling platform or combinations thereof may be used interchangeably to refer to a platform or interface that only allows a specific one to one coupling between an implant anchor and abutment and/or abutment assembly member. The single position one-way coupling platform allows for specific and/or individualized position, orientation and direction of an abutment, or a CAD/CAM personalized abutment or an individually adjustable abutment assembly with respect to the implant anchor.

Unless otherwise defined, all technical and scientific terms used herein have the same meaning as commonly understood by one of ordinary skill in the art to which this invention belongs. The materials, methods, and examples provided herein are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A-C are schematic illustration of PRIOR ART dental implant anchors and coupling interface;

FIG. 2A-C are schematic illustration of optional implant anchors having a single position one-way coupling platform according to an optional embodiment the present invention;

FIG. 3A-C are schematic illustration of optional implant anchors having a single position one-way coupling platform according to an optional embodiment the present invention;

FIG. 3D-F are schematic illustrations of a top view of optional single position one-way coupling platform according to optional embodiments the present invention;

FIG. 4A-Fare schematic illustrations of optional implant anchor insert adaptors according to an optional embodiments the present invention;

FIG. 5A-C are schematic illustrations of optional elongated implant anchor insert adaptors according to optional embodiment the present invention; and

FIG. 6 is a schematic illustration of an implant abutment fit with a single position one way coupling interface according to an optional embodiment of the present invention.

### DESCRIPTION OF THE PREFERRED EMBODIMENTS

The principles and operation of the present invention may be better understood with reference to the drawings and the accompanying description.

The following figure reference labels may be used throughout the description to refer to similarly functioning components are used throughout the specification hereinbelow:

32 off the shelf/prior art anchor;

36 anchor borehole;

36d borehole distal portion;

36p borehole proximal portion;

36t anchor bore threading;

37 beveled surface;

38 multi-position coupling interface;

700 single position one-way coupling platform anchor;

702a,b proximal one-way coupling member;

704 male single position one-way coupling member;

706 female single position one-way coupling member;

710 insert adaptor short single position one-way coupling platform;

712 insert adaptor external surface;

712d external surface distal portion;

712h insert adaptor length;

714 insert adaptor inner surface;

716 insert adaptor proximal end;

718 insert adaptor distal end;

718r distal end rim/flange;

720 insert adaptor long single position one-way coupling platform;

720d distal portion;

720e external surface;

720i internal surface;

720p proximal portion;

722 internal threading;

724 long insert coupling member;

736 anchor borehole;

736d borehole distal portion;

736p borehole proximal portion;

736t borehole threading;

738 one-way coupling interface;

738h coupling platform length;

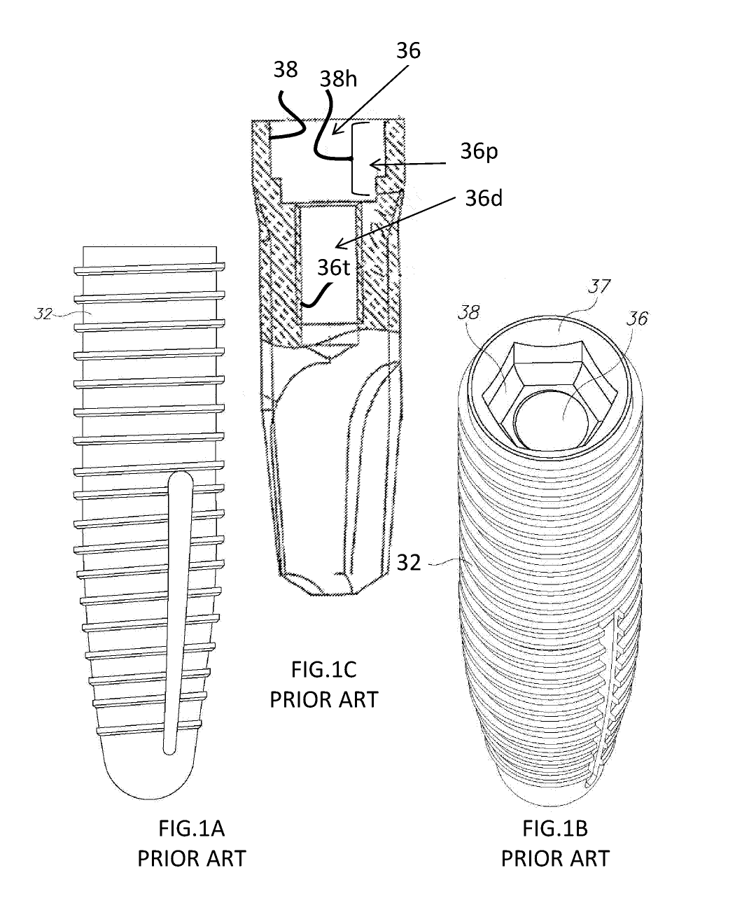

FIG. 1A-C shows various off the shelf prior art dental anchors 32 having a multi-position coupling interface 38 that serves both as an anti-rotational tooling surfacing and as a coupling interface for coupling implant abutments. Dental anchors 32 are screw-type dental implants comprising an externally-threaded, preferably self-tapping, body portion, for example as shown in FIG. 1A-B. The implant has engaging means for carrying and/or screwing and inserting the implant into an opening formed in bone tissue to receive the implant, as shown in FIG. 1B-C, in the form of an “internal hex” coupling platform configuration 38. The internal hex 38 facilitates both inserting anchor 32 into the jaw and for coupling an abutment thereto. Insertion of anchor 32 utilizing internal hex configuration 38 is facilitated with a corresponding tool such as a hex wrench, while they provide six different positions with which an abutment may be coupled.

The opening of the internal hex configuration 36 may also comprise leading beveled surface 37 allowing frictional sealing

FIG. 1C shows a longitudinal section through the length of anchor 32 revealing the length of an internal anchor bore 36 that includes a proximal portion 36p, a distal portion 36d and threading 36t along the surface of distal portion 36d. Threading 36t provides for interfacing with a locking screw that facilitates coupling anchor 32 with optional prosthodontic elements such as impression coping, abutments, abutments assemblies, restorations and the like in a secure manner utilizing a locking screw.

Such off the shelf and/or state of the art implant anchors are made of titanium or alloys thereof.

However, the introduction of adjustable and/or customizable dental implant abutment assembly and CAD/CAM facilitated individualized dental abutments and restorations, has surfaced a problem with such prior art and/or off the shelf implant anchors 32, such as those depicted in FIG. 1A-C, particularly with respect to the anchor's coupling platform 38. The problem with prior art coupling platforms 38 lays in that the available coupling interfaces provides multiple positions and orientation with which to couple the anchor to an abutment assembly and the restoration mounted thereon.

Accordingly, prior art anchors 32 and coupling interfaces 38 do not provide for ensuring that an abutment, an adjusted and/or customized and/or CAD/CAM individualized abutment, and the restoration mounted on the abutment, would be oriented and positioned according to clinical and/or morphological requirements for which they were designed.

Specifically prior art anchor's 32 having multi-position coupling interfaces, for example the internal hex 38 shown in FIG. 1A, provide multiple positions and/or orientations, specifically there are six positions in which a customized and/or CAD/CAM individualized abutment and/or restoration may be positioned with the anchor's coupling interface. Such customized and/or CAD/CAM individualized, abutments and restorations do not need multiple positioning options as the abutment and restoration are customized according to the specific clinical and morphological situation of a patient such that they are manufactured to assume the planned orientation and/or position within the jaw.

Accordingly, coupling interfaces 38 of prior art anchors 32, increase the likelihood of a mismatches and/or misalignment of an individually customized restoration dental implant systems, and CAD/CAM facilitated individualized abutment about prior art anchor 32: Therefore off the shelf implant anchors having a multi-position coupling platform increase the likelihood of placing a customized abutment assembly or a CAD/CAM individualized abutment in an incorrect clinical position, as at times the differences between individual positions are very subtle and not necessarily readily visible to the practitioner.

Prior art multi-position coupling interfaces may include any of the following interfaces: internal six receptor sockets, scalloped, internal dodecagon, external hex, internal hex, internal octagon, external octagon, external spline, external morse taper, internal morse taper, internal six lobe, internal tri lobe, internal six spline, internal thread, internal pentagon, external thread, internal square, external square, internal five lobe, internal four lobe, internal three spline, external triangle, internal eight spline, external six lobe, internal eight lobe, internal tube to tube and plug in. Each of these prior art coupling interfaces include at least two or more optional positions with which an anchor may be coupled to an abutment assembly and accordingly cannot ensure proper positioning of a customized or an individualized abutment assembly with an anchor.

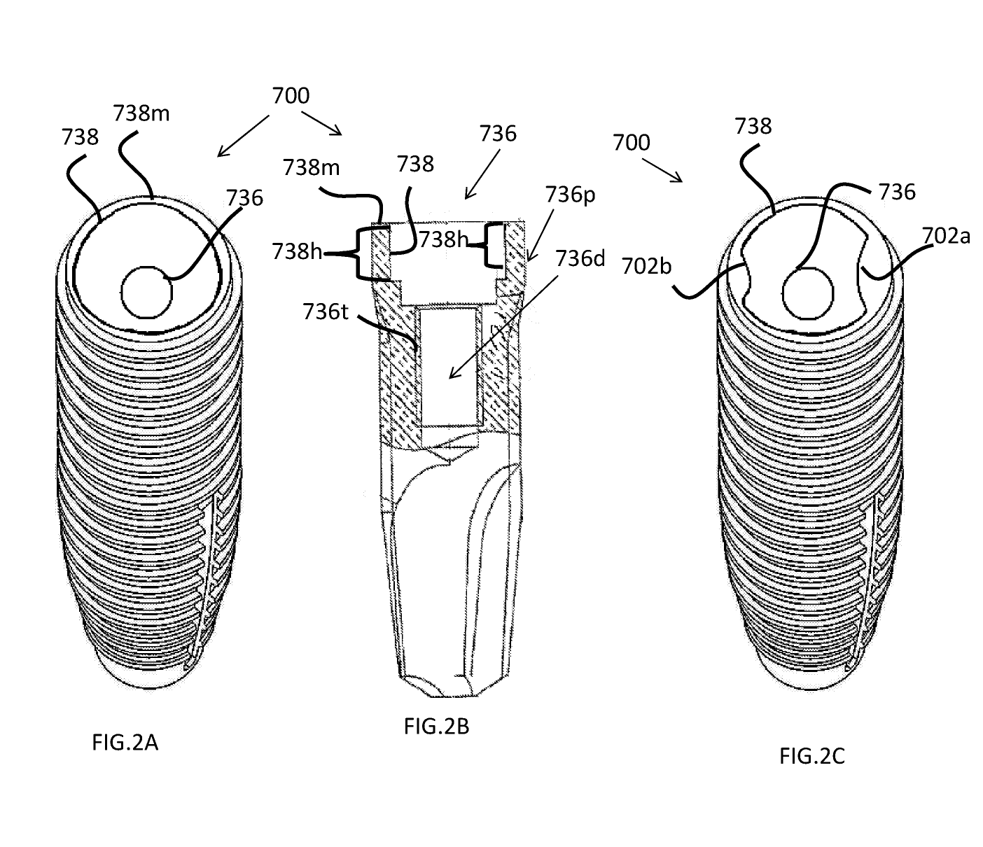

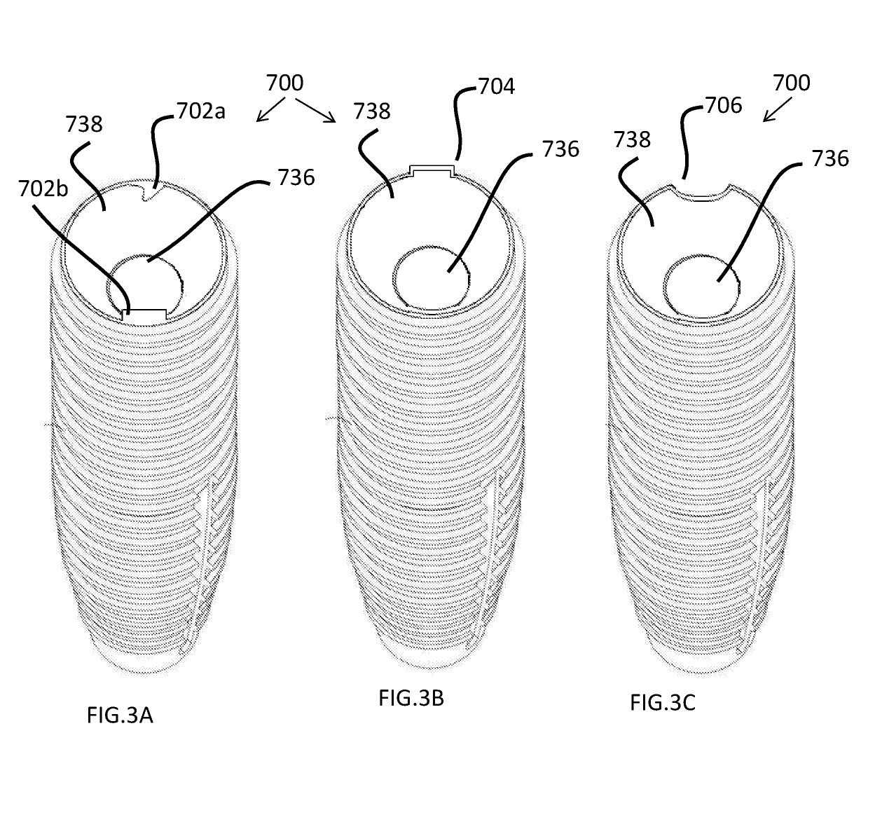

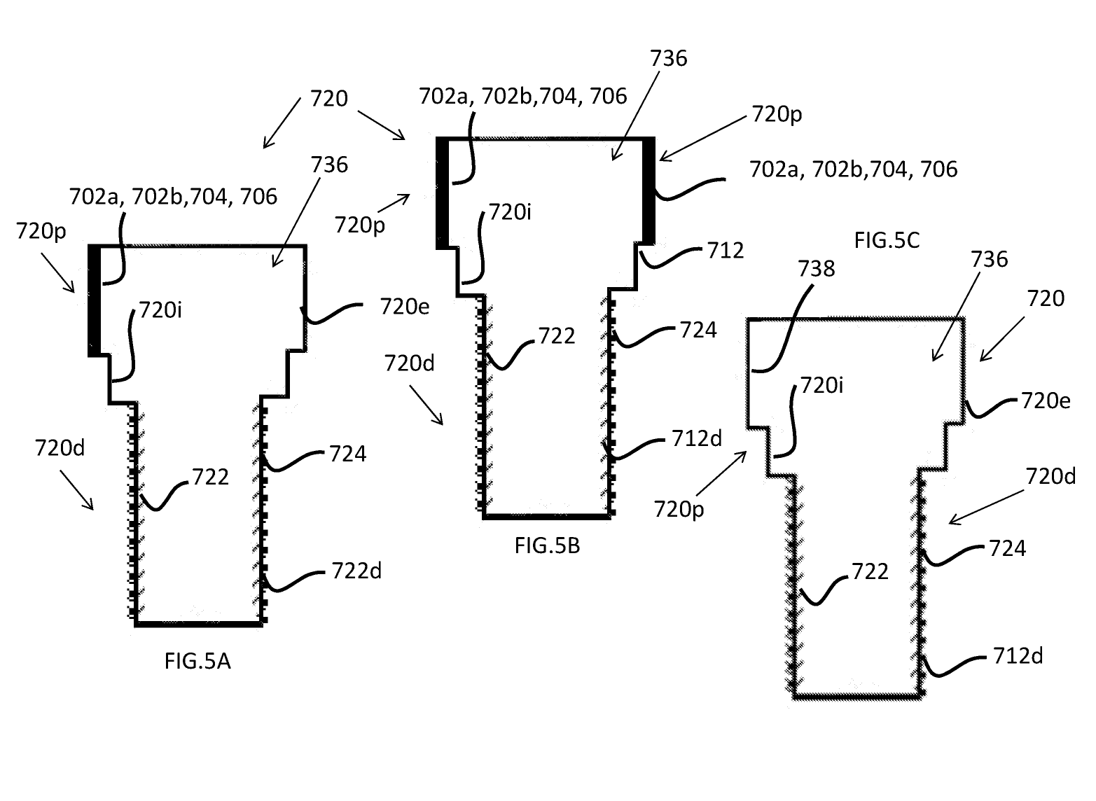

Now referring to FIG. 2-3 showing embodiments of the present invention that overcome the deficiencies of the prior art by providing a dental implant anchor 700 having a single position one-way coupling interface 738 including at least one coupling member 702 configured to provide a one-way coupling accuracy between implant anchors and corresponding abutments, provided so as to eliminate any mismatches between an anchor and an individualized abutment. Most preferably coupling interface 738 ensures that a customized dental implant abutment (FIG. 6) or a CAD/CAM abutment are correctly coupled with anchor 700, in the clinically planned and correct orientation.

In some embodiments, the CAD/CAM facilitated individualized restoration (not shown) is provided with a coupling interface that corresponds to the one-way coupling interface 738 of anchor 700.

In some embodiments, the customized abutment assembly is provided with a coupling interface that corresponds to the one way coupling interface 738 of anchor 700 to facilitate coupling therewith, for example as shown in FIG. 6.

Referring now to the drawings, FIG. 2A-C shows embodiments of the present invention showing dental implant anchor 700 having a single position one-way coupling interface 738 and a borehole 736. Borehole 736 as depicted in FIG. 2B comprises a proximal portion 736p and distal portion 736d, where distal portion 736d comprises threading 736t provided for coupling with a fixation screw.

FIG. 2A shows a preferred coupling interface 738 that defines an implant margin 738m of at least 0.3 mm. Preferably interface 738 is defined along the internal surface of proximal portion 736p of borehole 736. Preferably the single position one-way coupling interface 738 is characterized in that it is a continuous curved surface, defining an irregular circle having up to one line of symmetry. Preferably and optionally up to about 50% of the curved surface forming the connection platform 738 is a continuous curved surface having a constant radius.

Optionally and preferably the continuous curved surface forming platform 738 defines an oval, for example as shown in FIG. 2A, having up to one line of symmetry. Optionally and more preferably the oval platform 738 defines an egg shaped oval, also depicted in FIG. 2A.

FIG. 2B shows a long cross-sectional view of an implant anchor 700 revealing the borehole and its parts.

FIG. 2C shows an optional coupling interface 738 that further comprises indentations 702a, 702b that form optional coupling members to define the single position one-way coupling interface 738, such coupling member are shown in greater detail in FIG. 3A-F.

Now referring to FIG. 3A-C, showing an optional embodiment of single position one way coupling interface 738 of the present invention that further comprise at least one or more and preferably two coupling members 702-706.

One-way coupling interface 738 is preferably realized along the surface of proximal portion 736p, therein defining a coupling interface length 738h.

Single position one way coupling interface 738 is configured and shaped to define a single position one-way coupling axis with which an abutment, or other prosthodontic elements, having the corresponding coupling interface geometry, may be coupled with anchor 700. Most preferably, coupling interface 738 is defined with at least one coupling member 702, 702a, 702b, 704, 706. Optionally the coupling members 702-706 may be of optional form and may assume any shape. For example, coupling members may be a male coupling configuration as shown with coupling member 704 (FIG. 3B) or a female coupling member configuration 706 (FIG. 3C), wherein the male and/or female orientation is determined relative to the external surface of implant anchor 700.

Most preferably the coupling members forming interface 738 may have a corresponding coupling member (not shown) that may be disposed about optional prosthodontic elements for example including but not limited to a customized and/or individualized abutment, for example as shown in FIG. 6. FIG. 6 shows an optional abutment having a single position coupling platform 738′ comprising a coupling member 702′ configured to match and couple with the corresponding coupling member 702 disposed on interface 738.

Coupling interface 738 may be provided with at least one coupling member 702, 704, 706, for example as shown in FIG. 3A-C. Optionally coupling interface 738 may be provided with two or more coupling members 702a, 702b as shown in FIG. 3A

Optionally coupling members 702a, 702b, 704, 706 may be provided in optional shapes and/or configurations. Optionally coupling members 702, 702a, 702b, 704, 706 may be provided in a plurality of optional shapes and configuration having a profile for example including but not limited to curved, angled, polyhedral, polygonal of n sides wherein n is at least 2, cylindrical, rectangular, triangular, spherical, circular, any combination thereof or the like.

Coupling members 702-706 may optionally be provided in the form of a shaft, peg and/or cog and/or extension that extends out of the external surface borehole 736 along proximal portion 736p to form interface 738.

Optionally the coupling member 702-706 may form a peg extending from the internal surface forming interface 738. Optionally a female coupling member may form a recess along the internal surface forming interface 738.

Optionally male coupling member, for example as depicted by coupling members 702a, 702b, FIG. 3A, are configured in such a way so as to allow the formation of a matching and/or corresponding female coupling member (not shown) disposed on corresponding implant abutment coupling interface, for example, wherein the abutment's interface comprises a corresponding female coupling member configured to couple with coupling members 702a,b.

Coupling members 702 may optionally be provided in the form of a recess that extends into the external surface of interface 738, forming a recess about the lumen of anchor 700 defined by borehole 736. Optionally coupling member may be provided in the form of a female coupling member, for example as depicted by coupling members 706 configured to accept a corresponding male coupling member (not shown).

Optionally and preferably single position one-way coupling interface 738 may comprise two coupling members, for example 702a, 702b depicted in FIG. 3A, 3D-F, configured to allow a single coupling path along interface 738. Optionally and preferably each of the two coupling members may have a different shape, for example as shown in FIG. 3E-F. For example as shown in FIG. 3A coupling member 702a is a curved female coupling member while 702b is an angular male coupling member.

Optionally a first coupling member may be configured to be a male coupling member and a second coupling member may be configured to be a female coupling member.

Optionally a first coupling member 702a may be configured to be a male coupling member and a second coupling member 702b may also be configured to be a male coupling member, more preferably having different shape and/or geometry, for example as shown in FIG. 3D-F.

Optionally a first coupling member 702a may be configured to be a female coupling member and a second coupling member 702b may also be configured to be a female coupling member, more preferably having different shape and/or geometry.

Optionally first coupling member 702a and second coupling member 702b may be configured to be have the same shape however of different size in at least one dimension, for example as shown in FIG. 3D wherein both coupling member are cylindrical however coupling member 702b has a larger diameter than coupling member 702a, as shown.

FIG. 3D-3F show a top down view of an optional single position one-way coupling interface 738.

FIG. 3F show optional one-way coupling interface 738 comprising two differently shaped coupling members a curved coupling member 702b, for example assuming a cylindrical profile, and an angular coupling member 702a, assuming a triangular profile. FIG. 3E shows a further optional single position one-way coupling interface 738 comprising two differently shaped coupling members 702a,b including a trapezoid profile coupling member 702b and a triangular profile coupling member 702a.

In some embodiments, the CAD/CAM facilitated individualized abutments (not shown) is provided with a coupling interface that corresponds to the one way coupling interface 738 of anchor 700 about optional coupling members 702-706 that correspond and may be coupled in a one to one fashion.

In some embodiments, preferably the customized and/or adjusted abutment assembly (not shown) may be provided with a coupling interface that corresponds to the one way coupling interface 738 of anchor 700 to facilitate coupling therewith 700 about optional coupling members 702-706 in a one to one fashion.

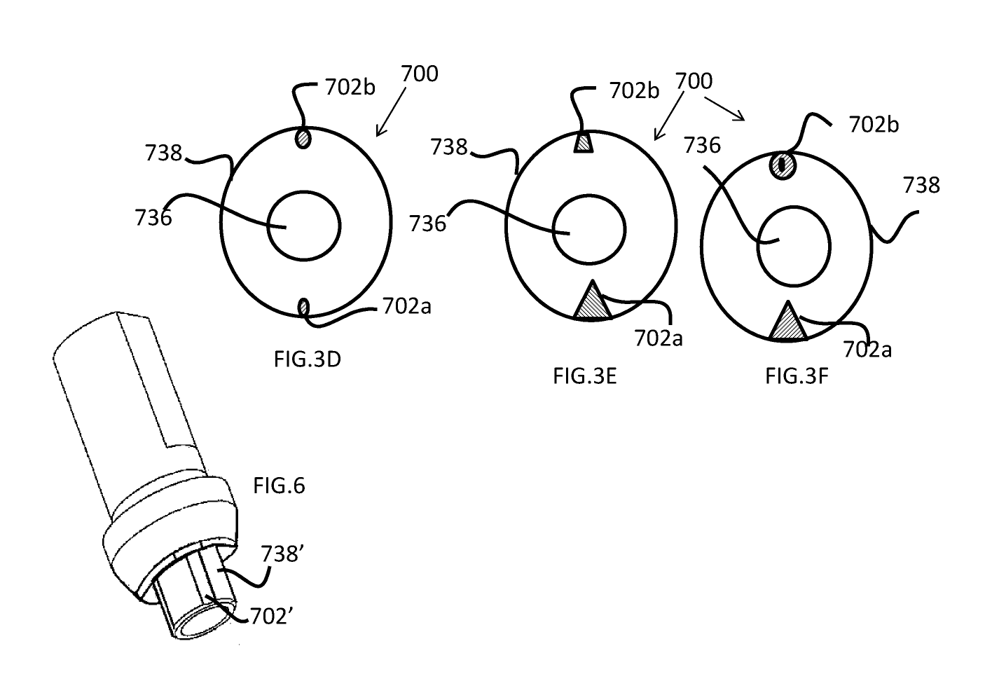

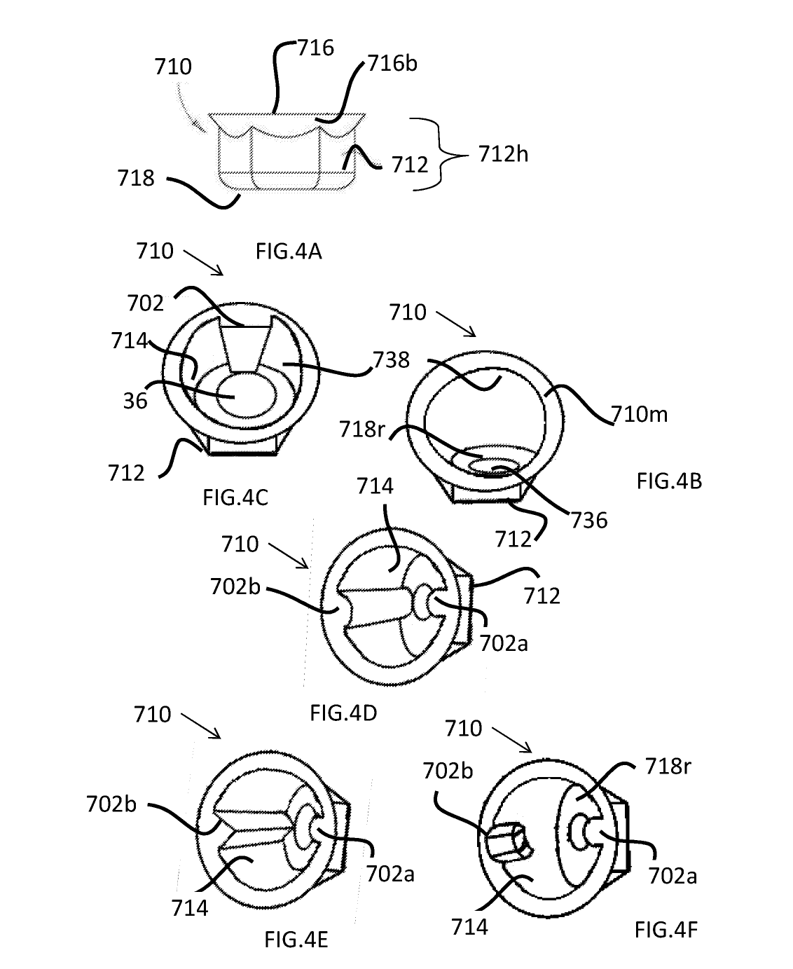

Now referring to FIG. 4-5 showing embodiments relating to dental implant inserts according to the present invention that provide for converting multi-position coupling interfaces and/or platforms 38 provided on off the shelf implant anchors 32, (FIG. 1A-C), to a single position one way coupling platform. Optionally the single position coupling platform may be any single position one way coupling platform, however more preferably the inserts feature single position one-way coupling platform 738.

FIG. 4A-E show an optional embodiment of a dental implant anchor insert adaptor 710 that provides for converting coupling interface of an off the shelf implant anchor to a single position one-way coupling interface along the proximal portion 36p of borehole 36, therein forming a short insert adaptor.

Optionally the length insert of adaptor 712h, FIG. 4A, corresponding preferably corresponds to the length of the connection platform 38h formed within the proximal portion 36p of borehole 36 of off the shelf implant 32, as shown in FIG. 1C.

FIG. 5A-C show optional embodiments of insert adaptors 720 that is provided to fit the length of borehole 36 of an off the shelf implant anchor 32 to convert the coupling platform from a multi-position to a single position connection platform.

The dental implant anchor insert adaptor 710,720 is provided to convert a multi-position coupling platform 38 disposed on an off the shelf dental implant anchor 32 to a single position one-way coupling platform 738, as previously described.

Preferably the insert adaptor 710 is configured to fit within at least the proximal portion 36p of borehole 36 wherein the coupling platform 38 is defined. Most preferably insert adaptor 710 has a substantially tubular body defining a distal end 718, a proximal end 716, an external surface 712 and an internal surface 714. Preferably the external surface 712 configured to correspond to and securely fit with a multi position coupling platform 38 while inner surface 714 is configured to define a single position one-way coupling platform, more preferably the one way coupling platform 738 according to embodiments of the present invention as previously described.

Optionally and preferably distal end 718 comprises an opening that is aligned with borehole distal portion 36d of borehole 36 of off the shelf implant anchor 32. Optionally opening at distal end 718 may define a rim and/or flange 718r.

Most preferably at least a portion of external surface 712 is configured to fit and correspond to any internal or external multi-position coupling platform 38. Optionally distal portion 718 may be configured to fit and correspond to any external multi-position coupling platform.

Optionally external surface 712 may be configured to fit and securely couple with any internal or external single position coupling platform.

Optionally insert adaptor 710, 720 may be configured to convert any internal multi position coupling platform 38 to any internal single position one way coupling platform, and more preferably the one way coupling platform 738 according to optional embodiments of the present invention.

Optionally insert adaptor 710, 720 may be configured to convert an internal multi position coupling platform 38 to an external single position one way coupling platform.

Optionally insert adaptor 710, 720 may be configured to convert an external multi position coupling platform 38 to an internal single position one way coupling platform.

Optionally insert adaptor 710,720 may be configured to convert an external multi position coupling platform to an external single position one way coupling platform.

Optionally insert adaptor 710,720 may be coupled with an off the shelf dental implant anchor 32 along external surface 712 by way of securely coupling external surface 712 with the surface of a multi position coupling platform 38 using a biocompatible adhesive material between the surfaces 712, 38. Optionally the adhesive material may include but is not limited to adhesives, dental cement, or the like biocompatible adhesive materials.

Optionally insert adaptor 710 may be coupled with said off the shelf dental implant anchor 32 with a fixation screw.

Optionally insert adaptor 710 may further comprise an internal rim and/or flange 718r that is define along the edge of the internal surface 714 adjacent to distal end 718, for example as shown in FIG. 4B, 4F. Optionally flange 718r may be utilized as a surface to affix, press and/or couple insert 710 to the internal borehole 36 at proximal portion 36p to facilitate coupling therewith.

Optionally insert adaptor 710 may comprise a beveled surface 716b adjacent to proximal end 716, for example as shown in FIG. 4A. Preferably beveled surface 716b is configured to correspond to a beveled surface 37 disposed adjacent to the proximal portion of the multi-position coupling platform 38 off the shelf implant anchor 32, as shown FIG. 1B.

FIG. 4A depicts a side view of a short single position one-way coupling platform insert adaptor 710 that provides for converting and/or transforming and/or switching the prior art coupling interface 38 of an off the shelf implant anchor 32 to a single position one-way coupling interface 738 that is disposed about borehole proximal portion 736p. Most preferably insert 710 comprises an external surface 712, defining a length 712h that corresponds to coupling interface 38 of anchor 32, for example as shown in FIG. 1B. Adaptor 710 comprises proximal end 716, distal end 718, and internal surface 714.

Most preferably external surface 712 may be affixed and securely coupled with coupling interface 38 with optional materials for example including but not limited to adhesives, cement, or the like biocompatible cementing, adhesive materials.

Optionally insert 710 may be coupled to a prior art anchor 32 about coupling interface 38 by friction or the like mechanical and/or chemical means for securely coupling external surface 712 to coupling interface 38 about borehole 36.

FIG. 4B shows an optional insert adaptor 710 where inner surface 714 defines a single position one-way coupling interface 738 for example as shown and previously described in FIG. 2A. Preferably the single position one-way coupling platform 738 is characterized in that it is a continuous curved surface, defining an irregular circle having up to one line of symmetry. Optionally up to about 50% of curved surface forming the connection platform 738 is a continuous curved surface having a constant radius.

Optionally and preferably the continuous curved surface forming platform 738 defines an oval having up to one line of symmetry. Optionally and more preferably the oval platform 738 defines an egg shaped oval.

Optionally curved surface 738 is configured to provide an implant margin 710m of at least 0.3 mm.

FIG. 4C shows an optional insert adaptor 710 having one coupling member 702 that defines a single position one-way coupling interface along internal surface 714.

FIG. 4D-F show perspective views of optional short insert 710 revealing the one-way coupling interface 738 formed by two optional coupling members 702a, 702b disposed opposite one another as previously described. FIG. 4D shows an insert 710 where both coupling member 702a,b have a cylindrical form of different size, similar to that depicted in FIG. 3D, where member 702a has a smaller diameter than that of coupling member 702b. Most preferably the differently sized coupling members 702a,b are provided so as to ensure a single position one way coupling platform is formed along the internal surface 714 of insert 710.

FIG. 4E shows an insert adaptor 710 having a first coupling member 702a in the cylindrical form while a second opposing coupling member 702b is provided with a triangular profile, therein the coupling members 702a,b are configured so as to allow only one way coupling with the single position coupling platform 738 by utilizing differently shaped coupling member, as shown and similarly configured in FIG. 3F.

FIG. 4F shows a further optional insert adaptor 710 where coupling member 702a is configured to take the form of a male configuration relative to inner surface 714 while coupling member 702b is configured to take the form of a female coupling member relative to inner surface 714 wherein coupling member 702b is in the form of an indentation along inner surface 714 to form an option a single position one-way interface 738.

FIG. 5A-C depicts a side view of a long one-way coupling platform insert 720 that provides for converting and/or transforming and/or switching the prior art borehole 36 about all of its portion distal 36d, proximal 36p and coupling interface 38 to optional one-way coupling interface 738 disposed about at least one of borehole proximal portion 736p and/or distal portion 736d.

Most preferably insert adaptor 720 comprises an external surface 720e, an internal surface 720i, a proximal portion 720p and a distal portion 720d.

Preferably external surface 720e is configured to match borehole 36 of off the shelf implant anchor 32. Most preferably external surface 720e disposed along proximal portion 720p is configured to correspond with be coupled with the multi-position coupling platform 38 of off the shelf implant 32 defined along the proximal portion 36p of borehole 36.

Most preferably external surface 720e disposed along distal portion 720p is configured to correspond with and coupled to the distal portion 36d of borehole 36. Optionally

[symbol]

Optionally external surface 720e may be affixed and securely coupled with coupling interface 38 with optional materials for example including but not limited to adhesives, cement, or the like biocompatible adhesive materials. Optionally insert 720 may be coupled to a prior art anchor 32 about coupling interface 38 by friction or the like mechanical and/or chemical means for securely coupling external surface 720e to coupling interface 38 about borehole 36.

Preferably the external surface 720e along distal portion 720d that defines a distal surface 724 is preferably provided to couple with and/or nullify prior art borehole threading 36t, shown in FIG. 1C. Optionally distal external surface 724 may be provided with the threading corresponding to borehole threading 36t. Optionally surface 724 may be provided with coupling members, graduations, scoring or the like that provide for associating with borehole threading 36t by way of an adhesive and/or cement.

Optionally and preferably long insert 720 comprises internal threading 722 that effectively replace borehole threading 36t.

Most preferably long insert may comprise at least one coupling member 702a, 702b, 704, 706, along the internal surface 720i along proximal portion 720p as previously described, to form a one-way coupling platform 738 as previously described.

FIG. 5A shows an optional embodiment of long insert 720 comprising one coupling member 702a, 702b, 704, 706, as previously described, that may be utilized to transform a prior art anchor 32 to a one-way coupling platform 738, where a multi-position coupling interface is converted to a single position one way coupling interface.

FIG. 5B shows an optional embodiment of long insert 720 comprising two coupling member 702a, 702b, 704, 706, as previously described, that may be utilized to transform the coupling interface 38 of a prior art anchor 32 to a single position one-way coupling platform 738.

FIG. 5C shows an optional embodiment of long insert 720 comprising a coupling platform 738 as previously described, that may be utilized to transform the multi-position coupling platform 38 of a prior art anchor 32 to a one-way coupling platform 738, where a multi-position coupling interface is converted to a single position one way coupling interface. Preferably the single position one-way coupling platform 738 is characterized in that it is a continuous curved surface, defining an irregular circle having up to one line of symmetry. Optionally up to about 50% of curved surface forming the connection platform 738 is a continuous curved surface having a constant radius.

Optionally and preferably the continuous curved surface forming platform 738 defines an oval having up to one line of symmetry. Optionally and more preferably the oval platform 738 defines an egg shaped oval.

Having described a specific preferred embodiment of the invention with reference to the accompanying drawings, it will be appreciated that the present invention is not limited to that precise embodiment and that various changes and modifications can be effected therein by one of ordinary skill in the art without departing from the scope or spirit of the invention defined by the appended claims.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

While the invention has been described with respect to a limited number of embodiments, it will be appreciated that many variations, modifications and other applications of the invention may be made.

What is claimed is:

1. A dental implant anchor insert adaptor (710) provided to convert a multi position coupling platform (38) disposed on an off the shelf dental implant anchor (32) to a single position one-way coupling platform (738), the insert adaptor configured to fit within at least the proximal portion (36p) of borehole (36) wherein the coupling platform (38) is defined, the insert adaptor (710) having a substantially tubular body defining a distal end (718), proximal end (716), an external surface (712) and an internal surface (714), said external surface (712) configured to correspond to and securely fit with a multi position coupling platform (38); said inner surface (714) configured to define a single position one-way coupling platform (738).

2. The insert adaptor of claim 1 wherein said adaptor is configured to convert an internal multi position coupling platform (38) to an internal single position one way coupling platform (738).

3. The insert adaptor of claim 1 wherein said adaptor is configure convert an internal multi position coupling platform (38) to an external single position one way coupling platform.

4. The insert adaptor of claim 1 wherein said adaptor is configure convert an external multi position coupling platform (38) to an internal single position one way coupling platform.

5. The insert adaptor of claim 1 wherein said adaptor is configure convert an external multi position coupling platform (38) to an external single position one way coupling platform.

6. The insert adaptor of claim 1 wherein said insert adaptor (710) is coupled with said off the shelf dental implant anchor (32) along said external surface (712) by way of securely coupling external surface (712) with the surface of said multi position coupling platform (38) using biocompatible adhesive material between said surfaces.

7. The insert adaptor of claim 2 wherein said biocompatible adhesive material is dental cement.

8. The insert adaptor of claim 1 wherein said insert adaptor (710) is coupled with said off the shelf dental implant anchor (32) with a fixation screw.

9. The insert adaptor of claim 1 wherein the distal end (718) comprises an internal rim/flange (718r) define along the edge of the internal surface (714) adjacent to said distal end (718) said flange (718r) provided to facilitating coupling said insert with a fixation screw.

10. The insert adaptor of claim 1 wherein the proximal end (716) comprises a beveled surface (716b) corresponding to a beveled surface (37) disposed adjacent to the proximal portion of the multi-position coupling platform (38) of a shelf implant anchor (32).

11. The insert adaptor of claim 1 having a length (712h) corresponding to the length of the connection platform (38h) formed within the proximal portion (36p) of borehole (36) of off the shelf implant (32).

12. The insert adaptor of claim 1 having a length corresponding to the length of the entire borehole (36) of said off the shelf dental implant (32) therein defining a long insert adaptor (720) having a proximal portion (720p) corresponding to the length of the connection platform (38) of off the shelf implant (32) and a distal portion (720d) corresponding to the length of the borehole distal portion (32d) of the off the shelf implant (32)

13. The insert adaptor of claim 12 of wherein said long insert adaptor (720) is coupled within the borehole (36) by way of a biocompatible adhesive.

14. The insert adaptor of claim 12 comprising an external surface (720e) along the length of said distal portion (720d) comprising a coupling surface (724) configured to couple over borehole threading (36t) of said off the shelf dental implant (32).

15. The insert adaptor of claim 14 wherein said coupling surface (724) is provided in the form of threading configured to correspond to and be threaded with matching threading (36t) of said off the shelf implant (32).

16. The insert adaptor of claim 13 or 14 wherein the internal surface (720i) of the distal portion (720d) comprises internal threading (722) for coupling a fixation screw.

17. The insert adaptor of claim 14 wherein said coupling surface (724) is configured to facilitate bonding of said insert (720) within borehole (36) of said off the shelf implant anchor (32) by way of a biocompatible adhesive.

18. The insert adaptor of claim 1 wherein said single position one-way coupling platform (738) is characterized in that it is a continuous curved surface.

19. The insert adaptor of claim 18 wherein said continuous curved surface defines an irregular circle having up to one line of symmetry.

20. The insert adaptor of claim 19 wherein up to about 50% of said curved surface is a continuous curved surface having a constant radius.

21. The insert adaptor of claim 18 wherein said curved surface is an oval having up to one line of symmetry.

22. The insert adaptor of claim 20 wherein said curved surface is an egg shaped oval.

23. The insert adaptor of claim 18 wherein said curved surface is configured to provide an implant margin (710m) of at least 0.3 mm.

24. The insert adaptor of claim 18 wherein said curved surface is configured to further comprise at least one coupling member (702, 702a, 702b, 704, 706).

25. The insert adaptor of claim 24 wherein said coupling member is selected from one of a male coupling member forming a peg extending from said surface or a female coupling member forming a recess along said surface.

26. The insert adaptor of claim 18 wherein said curved surface is configured to further comprise at least two coupling member.

27. The insert adaptor of claim 26 wherein said two coupling members are disposed opposite one another.

28. The insert adaptor of claim 26 wherein said two coupling members are configured to have different geometric shapes.

29. The insert adaptor of claim 26 wherein said two coupling members are configured to have different sizes along at least one dimension.

30. The insert adaptor of claim 26 wherein said two coupling members are configured to have the same sizes along at least one dimension.

31. The insert adaptor of claim 26 wherein both of said two coupling members are configured to be male coupling members or female coupling members.

32. The insert adaptor of claim 26 wherein one of said two coupling members is configured to be a male coupling member or a female coupling member.

33. The insert adaptor of claim 24 wherein said coupling member is configured to have a planar cross section profile of any regular geometric shape.

34. The insert adaptor of claim 24 wherein said coupling member may be configured to have a length up to the length of said internal surface (712).

35. A dental implant anchor (700) having a screw form configuration for placement within the maxilla or mandible having an external surface comprising threading facilitating placement within the maxilla or mandible, and a central borehole (736) for interfacing and/or coupling the implant anchor with additional prosthodontic elements, borehole (736) having a proximal portion (736p) and a distal portion (736d) that are continuous with one another, wherein the surface of the borehole proximal portion (736p) is a continuous curved surface defining a single position one-way coupling platform (738) provided for one-way coupling with said prosthodontic elements, said one way connection platform (738) characterized in that:
a. said curved surface is a continuous surface defining an irregular circle having up to one line of symmetry;
b. wherein up to about 50% of said curved surface is has a constant radius; and
c. wherein said curved surface provides an implant margin (738m) of at least 0.3 mm; and
d. wherein said curved surface is configured to further comprise at least one coupling member (702, 702a, 702b, 704, 706) extending from a portion of said curved surface.

36. The implant anchor of claim 35 wherein said coupling member is configured as a male coupling member forming a peg extending from said curved surface.

37. The implant anchor of claim 35 wherein said coupling member is configured as a female coupling member forming a recess along said curved surface.

38. The implant anchor of claim 35 wherein said curved surface is an oval.

39. The implant anchor of claim 38 wherein said curved surface is an egg shaped oval.

40. The implant anchor of claim 35 wherein said curved surface is configured to comprise at least two coupling member.

41. The implant anchor of claim 40 wherein said two coupling members are configured to have the same sizes along at least one dimension.

42. The implant anchor of claim 40 wherein both of said two coupling members are configured to be male coupling members or female coupling members.

43. The implant anchor of claim 40 wherein one of said two coupling members is configured to be a male coupling member or a female coupling member.

44. The implant anchor of claim 35 wherein said coupling member is configured to have a planar cross section profile of any regular geometric shape.

45. The implant anchor of claim 35 wherein said coupling member may be configured to have a length up to the length of said coupling platform (738h).

46. A dental implant abutment having distal end comprising a single position one-way coupling platform (738) provided to couple with and correspond to a single position one way coupling platform disposed the implant of any of claims 35-45.

47. A dental implant system including a dental implant anchor according to any of claims 35-45 and a dental implant abutment having a distal end configured to match the single position one way coupling platform of said dental implant.

48. The insert adaptor of any of claims 1-34 wherein said single position one-way coupling platform (738) is configured to correspond to and couple with a single position one-way coupling platform disposed on a prosthodontic elements selected from the group consisting of: impression coping, implant abutment, a personalized implant abutment, fixation screw, a CAD/CAM personalized implant abutment, a manually customizable abutment assembly, healing abutment, healing cap, cover screw.
